(19) United States
(12) Patent Application Publication
(10) Pub. No.: US 2026/0121124 A1
(43) Pub. Date: Apr. 30, 2026

(54) SUPERCONDUCTING SOLID STATE ELECTROLYTES WITH LOW ACTIVATION ENERGY

(71) Applicant: Toyota Motor Engineering & Manufacturing North America, Inc., Plano, TX (US)

(72) Inventors: Rana Mohtadi, Northville, MI (US); Oscar Tutusaus, Ann Arbor, MI (US); Jian Pan, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/428,768

(22) Filed: Dec. 22, 2025

Related U.S. Application Data
(63) Continuation-in-part of application No. 19/358,619, filed on Oct. 15, 2025.
Application No. 19/358,619 is a continuation of application No. 17/846,334, filed on Jun. 22, 2022, now Pat. No. 12,469,884.

(51) Int. Cl. H01M 10/0568; H01M 10/052; H01M 10/0562; H01M 10/39

(52) U.S. Cl. CPC H01M 10/0568; H01M 10/052; H01M 10/0562; H01M 10/399; H01M 2300/0048; H01M 2300/0065

(57) ABSTRACT

An electrochemical cell includes electrolyte includes a cathode, an anode, and an inorganic boron cluster solid state electrolyte that has a metal cation selected from the group consisting of Li⁺, Na⁺, K⁺, Mg²⁺, Ca²⁺, Zn²⁺, and Al³⁺, a composite salt mixture includes between 0.975 and 0.05 mole fraction of a first boron cluster salt and between 0.025 and 0.95 mole fraction of a second boron cluster salt. In some variations the composite salt mixture includes a third boron cluster salt and can have an activation energy less than 0.65 eV at one or more temperatures above -30^{o}C. The electrochemical cell can also include a catholyte, an anolyte, and/or a separator, and the catholyte, the anolyte, and/or the separator can include the inorganic boron cluster solid state electrolyte.

### CROSS-REFERENCE TO RELATED APPLICATION

This application is a continuation-in-part application of currently pending U.S. Patent Application No. 19/358,619, filed on October 15, 2025, which is a continuation application of U.S. Patent Application No. 17/846,334, filed on June 22, 2022, both of which are incorporated herein in their entirety by reference.

### TECHNICAL FIELD

The present disclosure generally relates to solid state electrolytes, and particularly to superconducting solid state electrolytes.

### BACKGROUND

Solid-state electrolytes provide many advantages in secondary battery design, including mechanical stability, no volatility, and ease of construction. Typical inorganic solid-state electrolytes having high ionic conductivity are sulfides-based electrolytes. For example, Zhang et al. reported that the ionic conductivity for a sulfide electrolyte can exceed 25 mS/cm, which is advantageous for battery applications (Zhang Z et al. Energy Environ. Sci., 2018, 11, 1945). However, sulfide-based electrolytes suffer from the high propensity to form H₂S toxic gases upon exposure to low level of moisture, which challenges their practical use. Other classes such as polymeric and other organic have inferior ionic mobility at technologically relevant temperatures below 60 °C.

The present disclosure addresses these issues with solid-state electrolytes, and other issues related to electrolytes.

### SUMMARY

In one form of the present disclosure, an electrolyte includes a composite salt mixture with between 0.975 and 0.05 mole fraction of a first boron cluster salt (e.g., a first closo-borate salt), between 0.025 and 0.95 mole fraction of a second boron cluster salt (e.g., a second closo-borate salt) that is different than the first boron cluster salt, and between 0.025 and 0.90 mole fraction of a third boron cluster salt (e.g., a third closo-borate salt) that is different than the first boron cluster salt and the second boron cluster salt. Also, at least two of the first, second, and third boron cluster salts are halogenated boron cluster salts, and the electrolyte has an activation energy less than 0.65 eV at one or more temperatures above -30^{o}C.

In another form of the present disclosure, an electrochemical cell includes an anode, a cathode, and a solid state electrolyte. The solid state electrolyte includes a composite salt mixture comprising between 0.975 and 0.05 mole fraction of a first boron cluster salt, between 0.025 and 0.95 mole fraction of a second boron cluster salt that is different than the first boron cluster salt, and between 0.025 and 0.90 mole fraction of a third boron cluster salt that is different than the first boron cluster salt and the second boron cluster salt. Also, at least two of the first, second, and third boron cluster salts are halogenated boron cluster salts, and the solid state electrolyte has an activation energy less than 0.65 eV at one or more temperatures above -30^{o}C.

In still another form of the present disclosure, a method includes mechanochemically mixing two or more boron cluster salts and forming an inorganic boron cluster solid state electrolyte. The two or more boron cluster salts include between 0.975 and 0.05 mole fraction of a halogen-free boron cluster salt and between 0.025 and 0.95 mole fraction of a halogenated boron cluster salt, and the inorganic boron cluster solid state electrolyte, when heated to a temperature at or below 200 ^{o}C and cooled, has an activation energy that is less than the activation energy of the solid state electrolyte before being heated.

These and other features of the nearly solvent-free or solvent free combined salt electrolyte and its preparation will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 is an Arrhenius plot of cationic conductivity versus temperature for a halogen-free boron cluster salt, and a composite salt mixture of a halogen-free boron cluster salt and a halogenated boron cluster salt according to the teachings of the present disclosure;

FIG. 2 is an Arrhenius plot of cationic conductivity versus temperature for a halogen-free boron cluster salt, and another composite salt mixture of a halogen-free boron cluster salt and a halogenated boron cluster salt according to the teachings of the present disclosure;

FIG. 3 is a graphical plot of cationic conductivity at 30 ^{o}C and activation energy versus % molar content of the halogenated boron cluster salt LiCB₁₁H₁₁F in a LiCB₁₁H₁₂ – LiCB₁₁H₁₁F composite salt mixture;

FIG. 4 is an Arrhenius plot of cationic conductivity versus temperature for a ternary boron cluster composite salt mixture according to the teachings of the present disclosure;

FIG. 5A is a ternary solid solution composition diagram for LiCB₁₁H₁₂ (LMC), LiCB₁₁H₁₁F (LMCF), and LiCB₁₁H₁₀F₂ (LMCDF) at 30 ^{o}C, and with a conductivity heat map overlaid thereon;

FIG. 5B is a ternary solid solution composition diagram for LMC, LMCF, and LMCDF, and an activation energy heat map, determined from the temperature range of 30-60 ^{o}C, overlaid thereon;

FIG. 6 is a graphical plot of current as a function of working electrode voltage at 25 ^{o}C illustrating anodic stability of a ternary boron cluster composite salt mixture according to the teachings of the present disclosure;

FIG. 7 is a ternary solid solution composition diagram for LMC, LMCF, and LMCDF at 25 ^{o}C, and an onset potential heat map overlaid thereon; and

FIG. 8 shows an electrochemical device according to the teachings of the present disclosure.

It should be noted that the figures set forth herein is intended to exemplify the general characteristics of the methods, algorithms, and devices among those of the present technology, for the purpose of the description of certain aspects. The figure may not precisely reflect the characteristics of any given aspect and are not necessarily intended to define or limit specific forms or variations within the scope of this technology.

### DETAILED DESCRIPTION

In an effort to overcome the issues related to sulfide-based electrolytes noted above, polymeric electrolytes and other organic electrolytes have been studied but found to exhibit inferior ionic mobility at technologically relevant temperatures below 60 °C. And recently, boron clusters salts have been reported to possibly form superionic conductors at above 50 °C, and for many of these salts at above 120 °C. In some instances, these super conductor high temperature phases can be stabilized at room temperature for limited closo-borate salts (e.g., see U.S. Patent No. 10,553,897; Kim S. et al. Nature Communications 10:1081, 2019 ; Tang W. S. et al. ACS Energy Lett. 2016, 1, 659−664). However, such an approach is problematic as the ionic conduction property, which includes the activation energy, is dictated by the intrinsic property and structural features of the high temperature phases. In fact, salts of closo-borates, and also most polymeric and other solid-state inorganic electrolytes, generally exhibit relatively high activation energies for cationic mobility at temperatures below 60 °C, which in turn implies a strong effect of the temperature on cationic mobility -- a property not desired for device operation. For example, the lowest activation energy for a room temperature superionic closo-borate lithium cation conductor has been reported to be greater than 0.29 eV (Kim S. et al., Nature Communications 10:1081, 2019). And the activation energy for Li closo-carbaborate salts exceeded 0.31 eV for temperatures above 39 °C and increased to 0.74 eV as these electrolytes were cooled below 39 °C (Tang W. S. et al. ACS Energy Lett. 2016, 1, 659−664).

In contrast to previous teachings, the present disclosure provides electrolytes with low activation energies (i.e., less than 0.65 eV) that include a composite salt mixture in which at least two different salts are in direct contact with each other, e.g., the composite salt mixture includes a combination of two or more boron cluster salts such as two or more closo-borate salts. In some variations, a composite salt mixture includes a halogen-free boron cluster salt and a halogenated boron cluster salt (also referred to herein simply as “combined halogen-free boron cluster/halogenated boron cluster salt”) and the combined halogen-free boron cluster/halogenated boron cluster salt provides an inorganic boron cluster solid state electrolyte with a cationic conductivity that is at least one order of magnitude greater than a cationic conductivity of the halogen-free boron cluster salt, at least one order of magnitude greater than a cationic conductivity of the halogenated boron cluster salt, and low activation energies (e.g., less than 0.65 eV). In addition, electrolytes with the “combined halogen-free boron cluster/halogenated boron cluster salt” can exhibit and/or maintain relatively low activation energies at high temperature (e.g., up to 150 ^{o}C) and sub-ambient temperatures (e.g., down to 0 ^{o}C). It should be understood that such composite salt mixtures can include only two boron cluster salts or more than two boron cluster salts, e.g., only three boron cluster salts, only four boron cluster salts, etc.

In other variations, an inorganic boron cluster solid state electrolyte according to the teachings of the present disclosure includes a composite salt mixture with a first boron cluster salt, a second boron cluster salt that is different than the first boron cluster salt, and a third boron cluster salt that is different than the first boron cluster salt and the second boron cluster salt. In such variations, the first boron cluster salt can have a content or concentration of between 0.975 and 0.05 mole fraction of the composite salt mixture, the second boron cluster salt can have a content or concentration of between 0.025 and 0.95 mole fraction of the composite salt mixture, and the third boron cluster salt can have a content or concentration of between 0.025 and 0.90 mole fraction of the composite salt mixture. Also, at least two of the first, second, and third boron cluster salts are halogenated boron cluster salts, and electrolytes with the ternary composite salt mixtures have an activation energy less than 0.65 eV at one or more temperatures above -30^{o}C. For example in some variations, electrolytes with ternary composite salt mixtures according to the teachings of the present disclosure have an activation energy less than 0.65 eV at temperatures between -20^{o}C and 150 ^{o}C.

In some variations, the first boron cluster salt is a halogen-free boron cluster salt, the second boron cluster salt is a first halogenated boron cluster salt, and the third boron cluster salt is a second halogenated boron cluster salt. And in at least one variation, the second halogenated boron cluster salt has more bonded halogen atoms than the first halogenated boron cluster salt and/or the second halogenated boron cluster salt has one or more different halogen atoms than the first halogenated boron cluster salt.

In other variations, the first boron cluster salt is a first halogenated boron cluster salt, the second boron cluster salt is a second halogenated boron cluster salt, and the third boron cluster salt is a third halogenated boron cluster salt. And in such variations, the third halogenated boron cluster salt can have more bonded halogen atoms than the first halogenated boron cluster salt and the second halogenated boron cluster salt and/or the third halogenated boron cluster salt can have one or more different halogen atoms than the first halogenated boron cluster salt and the second halogenated boron cluster salt.

In some variations of the present disclosure, the halogen-free boron cluster salt includes a cation selected from Li⁺, Na⁺, K⁺, Mg²⁺, Ca²⁺, Zn²⁺, and Al³⁺, and a boron cluster anion with the structure [B_{y}H_{(y-z)}R_{z}]²⁻, [CB(_{y-1})H_{(y-z)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, where y is an integer within a range of 6 to 12, (z) is an integer within a range of 0 to y, (t) is an integer within a range of 0 to (y−1), and R is a linear, branched-chain, or cyclic C1-C18 alkyl or fluoroalkyl group. And in at least one variation, the halogenated boron cluster salt includes a cation selected from Li⁺, Na⁺, K⁺, Mg²⁺, Ca²⁺, Zn²⁺, and Al³⁺, and a monovalent or multivalent halogenated boron cluster anion with the structure [B_{y}H_{(y-z-i)}R_{z}Xᵢ]²⁻, [CB(_{y-1})H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, where y is an integer within a range of 6 to 12, (z+i) is an integer within a range of 0 to y, (t+j) is an integer within a range of 0 to (y−1), X is F, Cl, Br, I, or a combination thereof, and R is a linear, branched-chain, or cyclic C1-C18 alkyl or fluoroalkyl group. In the alternative, X is a halogenated alkyl group containing CF₃. For example, in some variations the boron cluster anion of the halogen-free boron cluster salt and/or the halogenated boron cluster salt is B₁₂H₁₂²⁻, B₁₀H₁₀²⁻, CB₁₁H₁₂⁻ or CB₉H₁₀⁻, or a substituted derivative thereof. It should be understood that the boron clusters anions, such as B₁₂H₁₂²⁻, B₁₀H₁₀²⁻, CB₁₁H₁₂⁻, and CB₉H₁₀⁻, are attractive for solid-state batteries since such anions have better chemical stability. In another variation, the borate is not necessarily a closed cage “closo” and can be represented by any of the borate anion structures noted above.

A cation of the halogen-free boron cluster salt can be the same or different than a cation of the halogenated boron cluster salt. Accordingly, an electrolyte formulation with the composite salt mixture can include multiple different boron cluster anions and multiple different cations. The cation population of the electrolyte is composed of one or more cation species selected from the group consisting of Li⁺, Na⁺, K⁺, Mg²⁺, Ca²⁺, Zn²⁺, and/or Al³⁺, and wherein any single selected cation species may constitute from about 1 mole percent to 100 mole percent of the total moles of cations in the cation population.

In some variations, an electrolyte with the composite salt mixture can include one or more additional cation conductivity enhancing anions. The mole fraction of the one or more additional conductivity enhancing anion to the total anions in the composite salt mixture can be from about 0.01 to about 0.9. Also, the one or more additional conductivity enhancing anions can be selected from F⁻, Cl⁻, Br⁻, I⁻, RₓBF₄₋ₓ⁻, R_{y}PF_{6-y}⁻, SbF₆⁻, ClO₄⁻, SO₄²⁻, N(SO₂F)₂⁻, N(SO₂(CF₂)ₙCF₃)₂⁻, [NSO₂(CF₂)ₙ₊₁SO₂]⁻, or CF₃(CF₂)ₙSO₃⁻,where: n is 0 to 5; x is 0 to 4; y is 0 to 6; and R is a linear, branched, or cyclic alkyl group that can be unsubstituted, partially fluorinated, or fully fluorinated.

In at least one variation, an electrolyte is formulated from the composite salt mixture of two or more boron cluster salts as noted above, with an addition of an organic plastic crystal such that a soft solid electrolyte with appreciable cation conductivity(ies) is provided. The organic plastic crystal material can be a succinonitrile-glutaronitrile mixture where the molar percent of succinonitrile-glutaronitrile mixture between 0.01 to 50 molar % and the plastic state (i.e., the organic plastic crystal) promotes cation conductivities of more than 10⁻⁷ S/cm at 60 ºC. And in some variations, the electrolyte includes the composite salt mixture of two or more boron cluster salts, the organic plastic crystal, and the one or more additional cation conductivity enhancing anions.

In at least one variation, an electrolyte is formulated from the composite salt mixture of two or more boron cluster salts, with an addition of an inorganic-organic plastic crystal such that a soft solid electrolyte with appreciable cation conductivity(ies) is provided. The inorganic-organic plastic crystal material can include an organic cation(s) such as ammonium, pyridinium, piperidinium, phosphonium and inorganic anions such F⁻, Cl⁻, Br⁻, I⁻, RₓBF₄₋ₓ⁻, R_{y}PF_{6-y}⁻, SbF₆⁻, ClO₄⁻, SO₄²⁻, N(SO₂F)₂⁻, N(SO₂(CF₂)ₙCF₃)₂⁻, [NSO₂(CF₂)ₙ₊₁SO₂]⁻, or CF₃(CF₂)ₙSO₃⁻,where: n is 0 to 5; x is 0 to 4; y is 0 to 6; and R is a linear, branched, or cyclic alkyl group that can be unsubstituted, partially fluorinated, or fully fluorinated. The inorganic-organic plastic crystal material promotes cation conductivities of more than 10⁻⁷ S/cm at 60 ºC. And in some variations, the electrolyte includes the composite salt mixture of two or more boron cluster salts, the inorganic-organic plastic crystal, and the one or more additional cation conductivity enhancing anions.

In another variation, an electrolyte is formulated from the composite salt mixture of two or more boron cluster salts noted above, with an addition ionic liquid additive in the electrolyte. And in such variations the composite salt mixture of two or more boron cluster salts can be disposed in the ionic liquid and the concentration of the ionic liquid is between 0.01 and 50 molar percent.

In one form of the present disclosure, the composite salt mixture of two or more boron cluster salts is included in a solid-state electrolyte for a solid-state electrochemical device. In another form of the present disclosure, an electrolyte with the composite salt mixture of two or more boron cluster salts is in a partially liquid molten state at room temperature (i.e., 20-25 ^{o}C). And in still another form, an electrolyte with the composite salt mixture of two or more boron cluster salts is in a fully liquid molten state at room temperature.

In some variations, the composite salt mixture of two or more boron cluster salts is prepared by combining or mixing appropriate amounts of the two or more boron cluster salts using mechanochemical synthetic ball milling (i.e., mechanochemically mixing) followed by an optional heat treatment of the ball milled material at temperatures less than 200 ^{o}C and an optional ball milling homogenization step. In other variations, the composite salt mixture of two or more boron cluster salts is prepared using solution-based synthesis in which appropriate amounts of the two or more boron cluster salts are dissolved in a solvent (e.g., an ether solvent) followed by a solvent removal step and an optional ball milling homogenization step.

In some variations, an electrochemical device that includes an anode, a cathode, and an electrolyte with the composite salt mixture of two or more boron cluster salts in contact with the anode and the cathode is provided in the present disclosure. The electrochemical device can be a primary or a secondary battery or a subunit of a secondary battery. The anode is an electrode where alkali metal or alkali earth metal oxidation occurs during the device’s discharge and where reduction occurs during the device’s charge. Similarly, the cathode is an electrode where a cathode material reduction occurs during the device’s discharge and a cathode material oxidation occurs during the device’s charge.

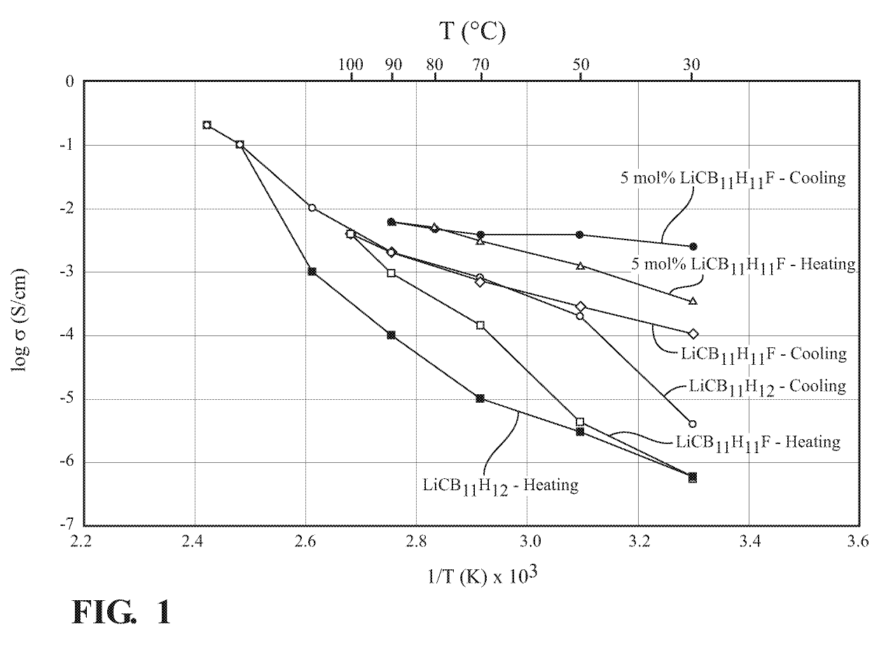

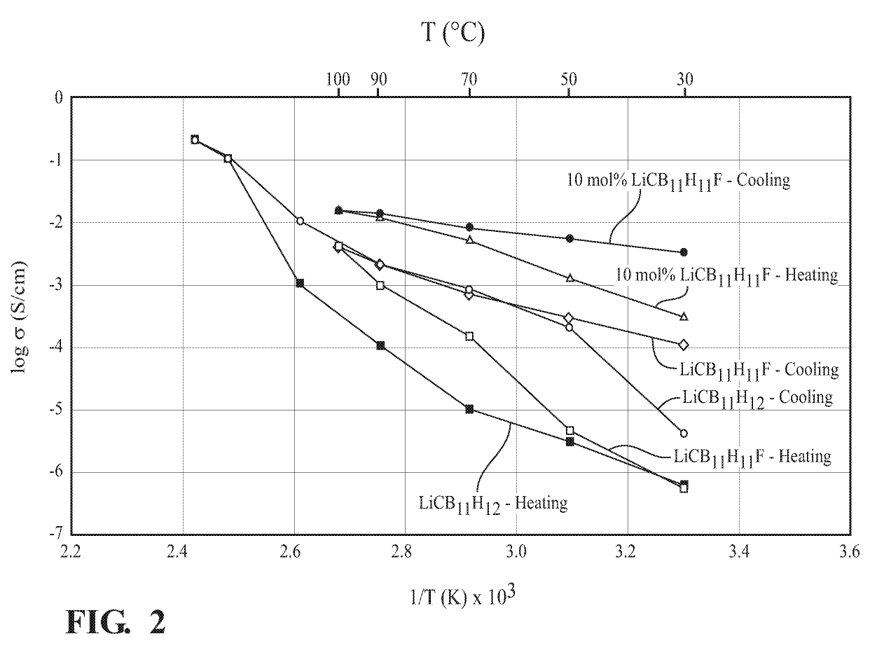

Referring now to FIGS. 1 and 2, Arrhenius plots of conductivity versus temperature for two combined halogen-free boron cluster/halogenated boron cluster salts according to the teachings of the present disclosure are shown. Particularly, FIG. 1 shows an Arrhenius plot for a combined 95 mol% LiCB₁₁H₁₂ / 5 mol% LiCB₁₁H₁₁F salt subjected to cationic conductivity measurements at 30, 50, 70, 80, and 90^{o}C during heating of the combined 95 mol% LiCB₁₁H₁₂ / 5 mol% LiCB₁₁H₁₁F salt (labeled “5 mol% LiCB₁₁H₁₁F - Heating”) and cationic conductivity measurements at 90, 80, 70, 50, and 30^{o}C following the heating of the combined 95 mol% LiCB₁₁H₁₂ / 5 mol% LiCB₁₁H₁₁F salt (labeled “5 mol% LiCB₁₁H₁₁F - Cooling”). FIG. 2 shows an Arrhenius plot for a combined 90 mol% LiCB₁₁H₁₂ / 10 mol% LiCB₁₁H₁₁F salt subjected to cationic conductivity measurements at 30, 50, 70, 90, and 100^{o}C during heating (labeled “10 mol% LiCB₁₁H₁₁F - Heating”) and cationic conductivity measurements at 100, 90, 70, 50, and 30^{o}C following the heating of the combined 90 mol% LiCB₁₁H₁₂ /10 mol% LiCB₁₁H₁₁F salt (labeled “10 mol% LiCB₁₁H₁₁F - Cooling”). And for comparison, FIGS. 1 and 2 also show cationic conductivities for neat LiCB₁₁H₁₂ during heating.

The combined 95 mol% LiCB₁₁H₁₂ / 5 mol% LiCB₁₁H₁₁F salt and the combined 90 mol% LiCB₁₁H₁₂ / 10 mol% LiCB₁₁H₁₁F salt were prepared by mixing LiCB₁₁H₁₂ and LiCB₁₁H₁₁F salts with a mortar and pestle, followed by ball milling at 700 revolutions per minute (RPM) for 24 hours to ensure uniformity of the combined LiCB₁₁H₁₂ / LiCB₁₁H₁₁F salts. A solid-state electrolyte pellet for each of the combined LiCB₁₁H₁₂ / LiCB₁₁H₁₁F salts was formed by pressing a given LiCB₁₁H₁₂ / LiCB₁₁H₁₁F salt mixture under at least 120 MPa of pressure. Also, carbon coated aluminum foil was used as the working electrode and the counter electrode of a two-electrode cell, and a solid-state electrolyte pellet of the combined 95 mol% LiCB₁₁H₁₂ / 5 mol% LiCB₁₁H₁₁F salt or the combined 90 mol% LiCB₁₁H₁₂ / 10 mol% LiCB₁₁H₁₁F salt was in direct contact with the working and counter electrodes during cationic conductivity measurements.

Referring particularly to FIG. 1, the combined 95 mol% LiCB₁₁H₁₂ / 5 mol% LiCB₁₁H₁₁F salt exhibited cationic conductivities of about 3.6 x 10⁻⁴ S/cm at 30 ^{o}C initially and of about 2.2 x 10⁻³ S/cm at 30 ^{o}C after heating. In contrast, the neat LiCB₁₁H₁₂ salt exhibited cationic conductivities initially of about 6.0 x 10⁻⁷ S/cm at 30^{o}C and about 4.0 x 10⁻⁶ at 30^{o}C after heating. Accordingly, an increase in cationic conductivity of the combined 95 mol% LiCB₁₁H₁₂ / 5 mol% LiCB₁₁H₁₁F salt after heat treatment was observed, as was an extremely low activation energy of 0.209 eV, and the cationic conductivity of the combined 95 mol% LiCB₁₁H₁₂ / 5 mol% LiCB₁₁H₁₁F salt at 30^{o}C was greater than about 500 to 1000 times the cationic conductivity of the LiCB₁₁H₁₂.

Referring particularly to FIG. 2, the combined 90 mol% LiCB₁₁H₁₂ / 10 mol% LiCB₁₁H₁₁F salt exhibited cationic conductivities initially of about 3.2 x 10⁻⁴ S/cm at 30^{o}C and about 3.2 x 10⁻³ S/cm at 30^{o}C following the heating cycle. In contrast, and as noted above, the neat LiCB₁₁H₁₂ salt exhibited cationic conductivities initially of about 6.0 x 10⁻⁷ S/cm at 30^{o}C and about 4.0 x 10⁻⁶ S/cm at 30^{o}C following the heating cycle. Accordingly, an increase in cationic conductivity of the combined 90 mol% LiCB₁₁H₁₂ / 10 mol% LiCB₁₁H₁₁F salt after heat treatment was observed, as was an extremely low activation energy of less than 0.3 eV, and the cationic conductivity of the combined 90 mol% LiCB₁₁H₁₂ / 10 mol% LiCB₁₁H₁₁F salt at 30^{o}C was greater than about 500 to 1000 times the cationic conductivity of the LiCB₁₁H₁₂.

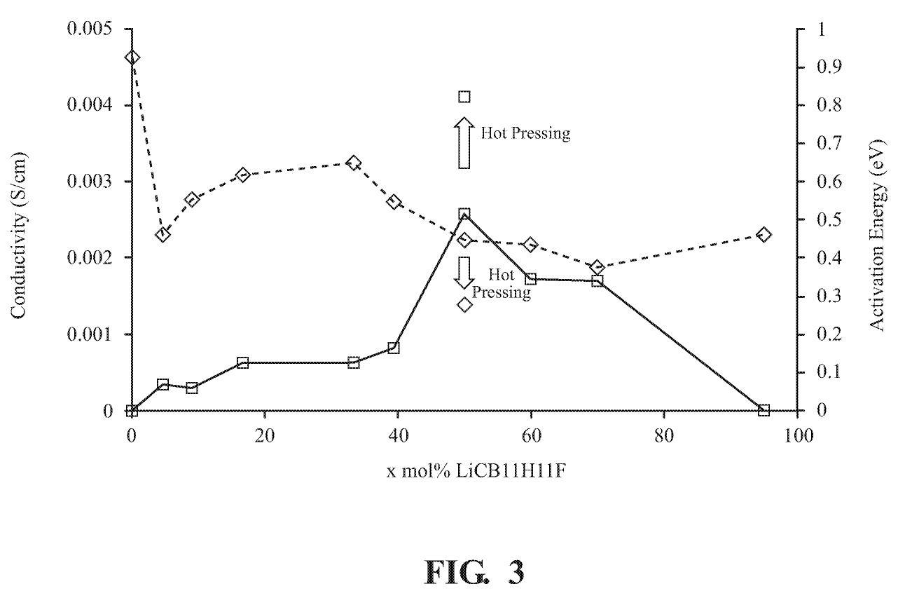

Referring now to FIG. 3, a plot of conductivity at 30^{o}C and activation energy calculated from the temperature range 30-60 °C for a plurality LiCB₁₁H₁₂ – LiCB₁₁H₁₁F compositions is shown. The compositions were cold pressed and not subjected to thermal activation, except for the two data points shown for a 50 mol% LiCB₁₁H₁₂ – 50 mol% LiCB₁₁H₁₁F composition. And as observed from FIG. 3, the conductivity of 100 mol% LiCB₁₁H₁₂ and 5 mol% LiCB₁₁H₁₂ – 95 mol% LiCB₁₁H₁₁F (solid line) is very low compared to desired compositions of LiCB₁₁H₁₂ and LiCB₁₁H₁₂ For example, compositions such as 50 mol% LiCB₁₁H₁₂ – 50 mol% LiCB₁₁H₁₁F can be greater than 1000 times that of 100 mol% LiCB₁₁H₁₂ and greater than 1000 times that of 100 mol% LiCB₁₁H₁₁F. In addition, the plot of conductivity versus composition illustrated a specific range or “sweet spot” of compositions that provide enhanced conductivity at 30^{o}C. In some variations the range of compositions that provide enhanced conductivity is between about 60 mol% LiCB₁₁H₁₂ – 40 mol% LiCB₁₁H₁₁F and about 20 mol% LiCB₁₁H₁₂ – 80 mol% LiCB₁₁H₁₁F, while in other variations the range is between about 55 mol% LiCB₁₁H₁₂ – 45 mol% LiCB₁₁H₁₁F and about 25 mol% LiCB₁₁H₁₂ – 75 mol% LiCB₁₁H₁₁F. And in at least one variation the range of compositions that provide enhanced conductivity is between about 55 mol% LiCB₁₁H₁₂ – 45 mol% LiCB₁₁H₁₁F and about 30 mol% LiCB₁₁H₁₂ – 70 mol% LiCB₁₁H₁₁F. In addition, the 50 mol% LiCB₁₁H₁₂ – 50 mol% LiCB₁₁H₁₁F composition was further hot pressed and this hot pressed composition exhibited an even higher conductivity (almost two time greater) compared to the 50 mol% LiCB₁₁H₁₂ – 50 mol% LiCB₁₁H₁₁F composition without hot pressing.

Still referring to FIG. 3, and regarding the activation energy calculated from the temperature range 30-60^{o}C, for the plurality LiCB₁₁H₁₂ – LiCB₁₁H₁₁F compositions (dashed line), all of the tested LiCB₁₁H₁₂ – LiCB₁₁H₁₁F compositions that included LiCB₁₁H₁₁F exhibited an activation energy less than 0.65 eV. In some variations (i.e., for some compositions), the activation energy was less than 0.61 eV, while in other variations the activation energy was less 0.58 eV. In at least one variation the activation energy was less than 0.51 eV, and in some variations the activation energy was less than 0.47 eV, for example, less than 0.42 eV and less than 0.40 eV. And for the 50 mol% LiCB₁₁H₁₂ – 50 mol% LiCB₁₁H₁₁F composition that was further hot pressed, this sample exhibited an activation energy less than 0.33 eV.

Accordingly, it should be understood that a simple or random combination of two or more boron cluster salts does not inherently provide the composite salt mixture of two or more boron cluster salts according to the teachings of the present disclosure. Stated differently, a specific range of compositions according to the teachings of the present disclosure provide a composite salt with enhanced conductivity and low activation energy.

It should also be understood from FIGS. 1, 2, and 3 that the combined halogen-free boron cluster / halogenated boron cluster salts according to the teachings of the present disclosure have or exhibit a cationic conductivity that is at least one order of magnitude greater than a cationic conductivity of the halogen-free boron cluster salt and/or at least one order of magnitude greater than a cationic conductivity of the halogenated boron cluster salt. In some variations, the combined halogen-free boron cluster / halogenated boron cluster salts according to the teachings of the present disclosure have or exhibit a cationic conductivity that is at least two orders of magnitude greater than the cationic conductivity of the halogen-free boron cluster salt and/or at least two orders of magnitude greater than the cationic conductivity of the halogenated boron cluster salt. And in at least one variation, the combined halogen-free boron cluster / halogenated boron cluster salts according to the teachings of the present disclosure have or exhibit a cationic conductivity that is between two and three orders of magnitude greater than the cationic conductivity of the halogen-free boron cluster salt and/or between two and three orders of magnitude greater than the cationic conductivity of the halogenated boron cluster salt, and an activation energy less than 0.65 eV, e.g., less than 0.55 eV, less than 0.45 eV, and/or less than 0.35 eV.

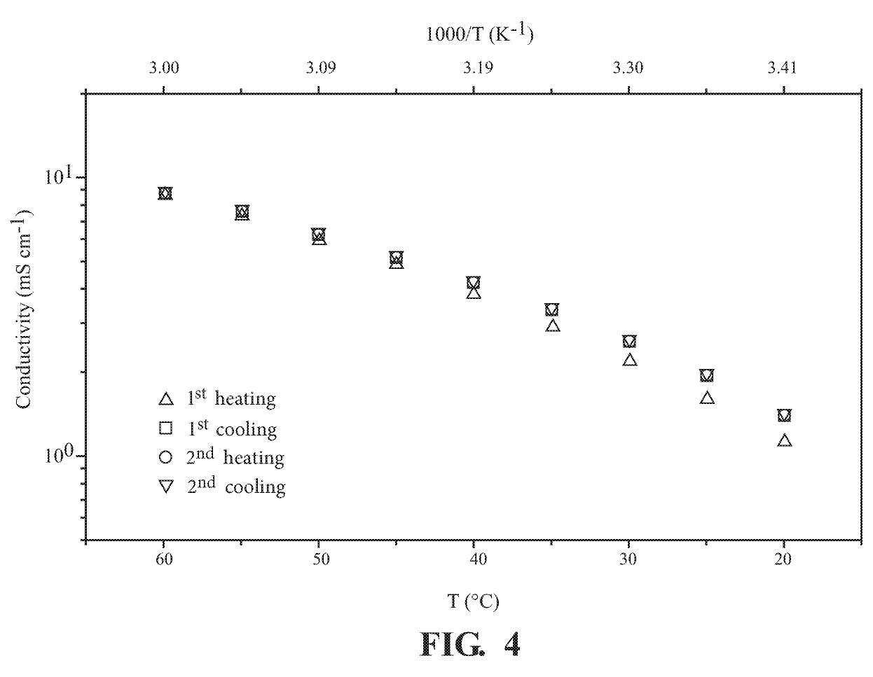

And while FIGS. 1-3 illustrate the enhanced properties of electrolytes with combined binary boron cluster composite salt mixtures, FIGS. 4-7 illustrate the enhanced properties of electrolytes with ternary boron cluster composite salt mixtures as described below.

Several distinct (different) ternary composite salt mixtures were synthesized by mixing, in a glove box filled with an inert gas with both H₂O and O₂ less than 0.1 ppm, between 20-900 milligrams of LiCB₁₁H₁₂ with between 20-900 milligrams of LiCB₁₁H₁₁F and between 20-900 milligrams of LiCB₁₁H₁₀F₂ in a mortar, and then grinding each salt mixture with a pestle for 2-10 minutes. Each mixture of salt powders was then loaded into 10-50 mL zirconia jars with zirconia milling balls (2-6 big balls and 4-12 small balls with a diameter of 3-7 mm) and the jars were sealed to avoid contacting air. The sealed jars were transferred from the glove box to a ball mill machine and ball milled at 400-700 rpm for 2-24 hours with 0-5 minutes rest after each hour. Then, the sealed jars were transferred back to the glove box and opened to collect final ternary composite salt mixtures that were used for testing/evaluation.

Referring to FIG. 4, an Arrhenius plot illustrating the superconductivity defined as measured conductivities of or greater than 10⁻⁴ S/cm and low activation energy of a ternary composite salt solid solution (also referred to herein simply as “ternary composite salt”) according to the teachings of the present disclosure is shown. The ternary composite salt was formulated as described above and had a molar ratio of LiCB₁₁H₁₂ (LMC):LiCB₁₁H₁₁F (LMCF):LiCB₁₁H₁₀F₂ (LMCDF) equal to 0.5:0.375:0.125, respectively, i.e., the sum of the mole fractions of the first, second, and third boron cluster salts equals 1.000. Conductivity measurements were taken during heating of the 0.5 LMC:0.375 LMCF:0.125 LMCDF composite salt mixture from 20^{o}C to 60^{o}C, then cooling of the 0.5 LMC:0.375 LMCF:0.125 LMCDF composite salt mixture from 60^{o}C to 20^{o}C, reheating the 0.5 LMC:0.375 LMCF:0.125 LMCDF composite salt mixture from 20^{o}C to 60^{o}C, and then cooling the 0.5 LMC:0.375 LMCF:0.125 LMCDF composite salt mixture from 60^{o}C to 20^{o}C. And as observed from FIG. 4, the ternary composite salt had an activation energy, after being heated and cooled, that was less than the activation energy before being heated. Stated differently, the data for the 1^{st} heating cycle shown in FIG. 4 has a higher slope than the data for 2^{nd} heating and cooling cycle. FIG. 4 also illustrates that the ternary composite salt exhibits superconductivity and low activation energy in the temperature range 20-60^{o}C. And in some variations, the 0.5 LMC:0.375 LMCF:0.125 LMCDF composite salt mixture exhibits an activation energy less than 0.65 eV at one or more temperatures above -30^{o}C.

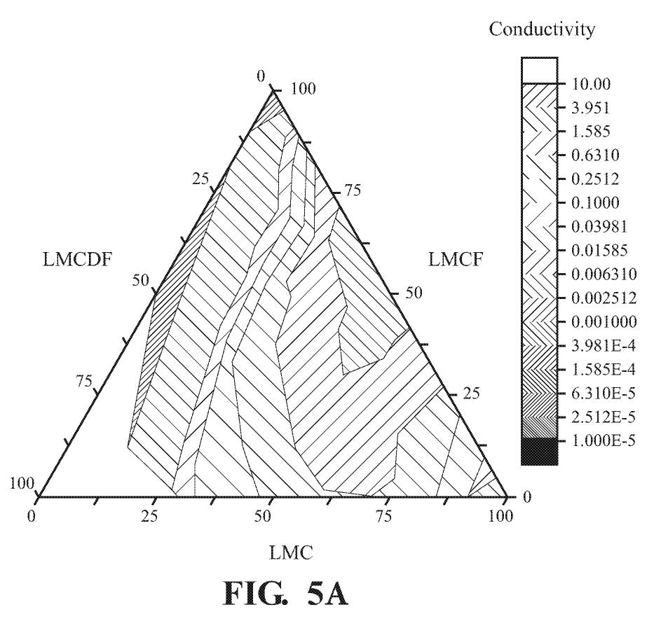

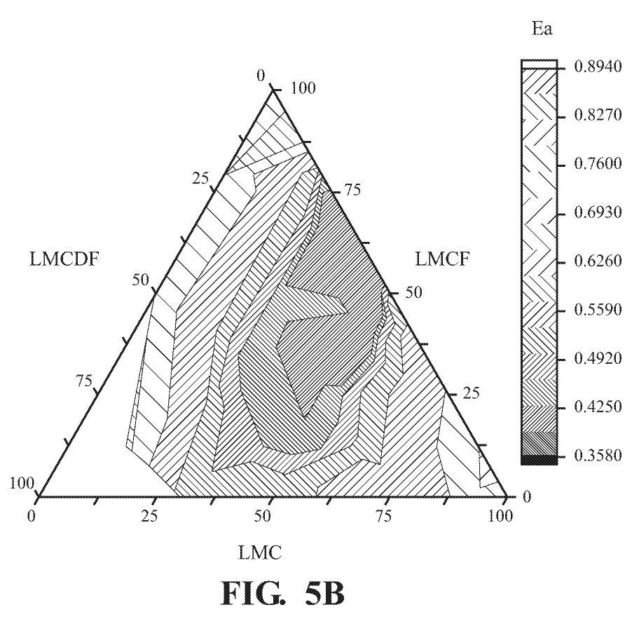

Referring to FIGS. 5A-5B, a ternary solid solution composition diagram of LMC, LMCF, and LMCDF is shown with a conductivity at 30^{o}C heat map (FIG. 5A) and an activation heat map (FIG. 5B) overlaid thereon. And as observed from FIGS. 5A-5B, exemplary ternary composite mixtures exhibit superconductivity exceeding 10⁻⁴ S/cm (FIG. 5A) with low activation energies (e.g., less than 0.65 eV).

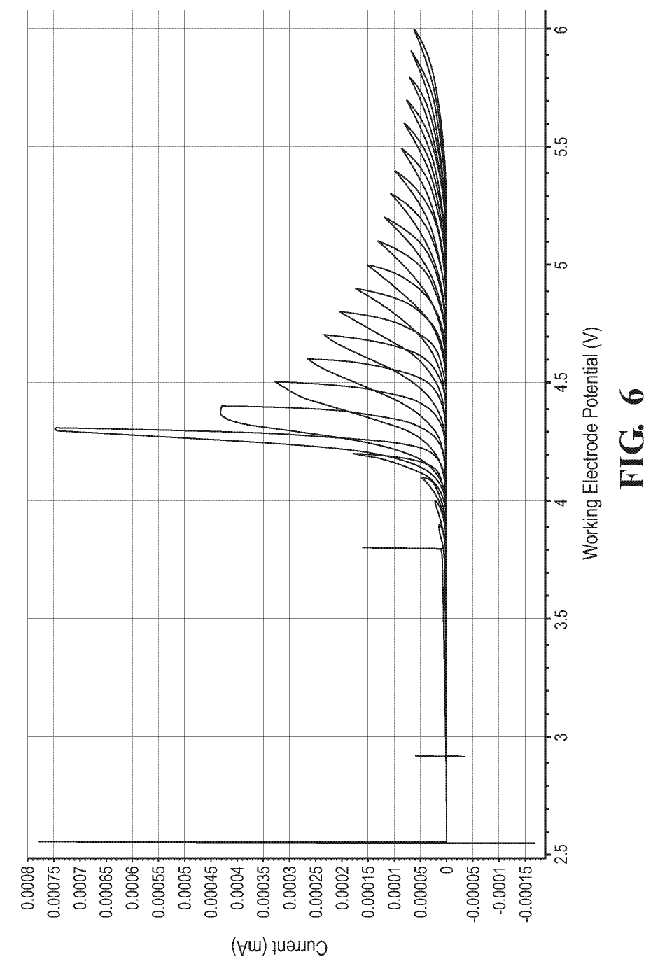

Referring to FIG. 6, a graphical plot of current as a function of sweeping potential (voltage) of a working electrode illustrates the anodic stability of the 0.5 LMC:0.375 LMCF:0.125 LMCDF composite salt mixture. That is, the0.5LMC:0.375 LMCF:0.125 LMCDF composite salt mixture did not experience significant oxidation current until the sweeping voltage reached 4.3 V.

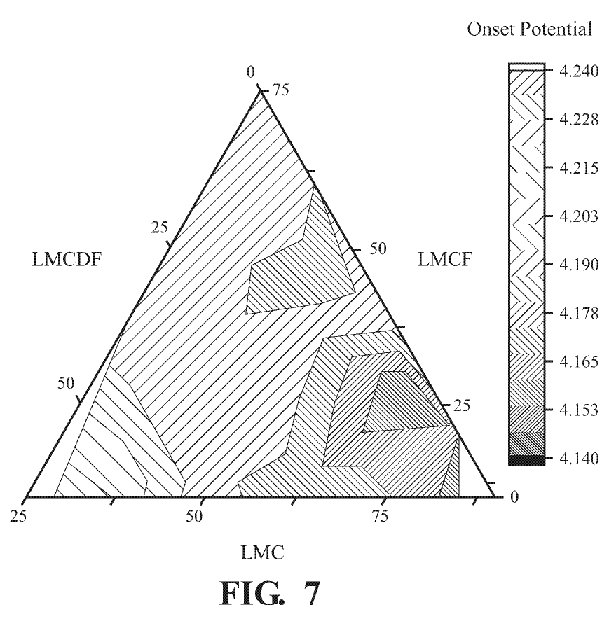

Referring to FIG. 7, a ternary solid solution composition diagram of LMC, LMCF, and LMCDF is shown with an onset potential heat map overlaid thereon. And as observed from FIG. 7, a wide range of LMC-LMCF-LMCDF composite salt compositions exhibit high oxidative stability exceeding 4.1 V.

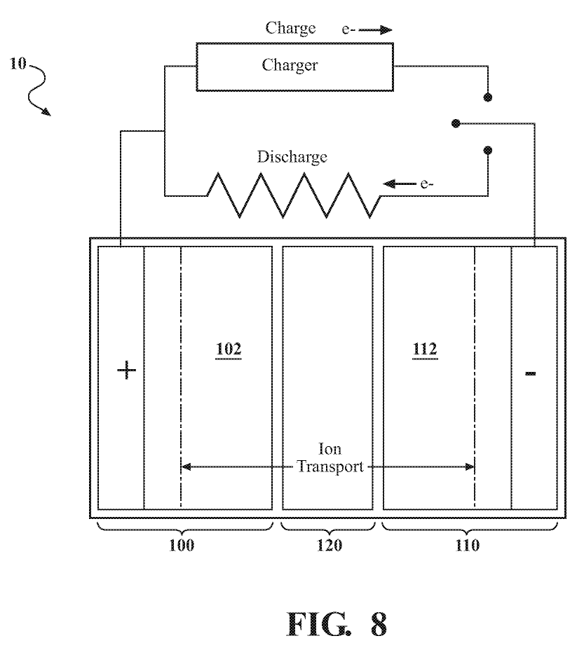

Referring now to FIG. 8, an electrochemical device 10 according to the teachings of the present disclosure is shown. In some variations, the electrochemical device 10 is a solid state electrolyte (SSE) electrochemical device that includes a cathode 100, with or without a catholyte 102, an anode 110, with or without an anolyte 112, and a cell separator (also referred to herein simply as a “separator”) 120. It should be understood that the separator 120 electrically isolates the cathode 100 from the anode 110, but allows ionic conduction therebetween. In some variations, the separator 120 functions as both a ‘separator” between the cathode 100 and the anode 110, and as a solid state electrolyte for the electrochemical device 10. In other variations, a solid state electrolyte can be present between the cathode 100 and the anode 110, in addition to the separator 120.

The cathode 100 can be an insertion cathode, a conversion cathode, or an organic cathode, and the anode 110 can be an intercalation anode, a metal anode, an alloy anode, a conversion anode or an organic anode. The electrochemical device 10 includes the inorganic boron cluster solid state electrolyte according to the teachings of the present disclosure which includes a metal cation selected from Li⁺, Na⁺, K⁺, Mg²⁺, Ca^{2+,} Zn²⁺, and Al³⁺, and the composite salt mixture of two or more boron cluster salts disclosed herein.

In some variations, the inorganic boron cluster solid state electrolyte as disclosed herein is used as the separator 120, is present in the catholyte 102, and/or is present in the anolyte 112 of the electrochemical device 10. As used herein, the term “catholyte” refers to solid state electrolyte blended in a cathode to enable and/or enhance cationic diffusion in the cathode electrode structure, and the term “anolyte” refers to solid state electrolyte blended in an anode to enable and/or enhance cationic diffusion in the anode electrode structure.

In at least one variation, the separator 120 is not formed from the inorganic boron cluster solid state electrolyte as disclosed herein. As used herein, the phrase “inorganic boron cluster solid state electrolyte” refers to a solid state electrolyte that includes or incorporates in whole or in part boron clusters such as but not limited to B₁₂H₁₂²⁻, CB₁₁H₁₂⁻, CB₉H₁₀⁻, and/or B₁₀H₁₀²⁻, and thus the phrase “not an inorganic boron cluster based electrolyte” refers to a solid state electrolyte that does not include or incorporate in whole or in part boron clusters, e.g., B₁₂H₁₂²⁻, CB₁₁H₁₂⁻, CB₉H₁₀⁻, and/or B₁₀H₁₀²⁻. Non-limiting examples of such electrolytes include sulfide solid state electrolytes, hydride solid state electrolytes, polymer solid state electrolytes, oxide solid state electrolytes, halide-type solid state electrolytes, plastic crystal solid state electrolytes, inorganic-organic crystal plastic solid state electrolytes, and combinations thereof.

In some variations, the catholyte 102 can be formed only from the inorganic boron cluster solid state electrolyte as disclosed herein, or in the alternative the catholyte 102 can include the inorganic boron cluster solid state electrolyte as disclosed herein in combination with another solid state electrolyte, that is not an inorganic boron cluster based electrolyte, such as sulfide solid state electrolytes, hydride solid state electrolytes, polymer solid state electrolytes, oxide solid state electrolytes, halide-type solid state electrolytes, plastic crystal solid state electrolytes, inorganic-organic plastic crystal solid state electrolytes, and combinations thereof.

Similarly, the anolyte 112 can be formed only from the inorganic boron cluster solid state electrolyte as disclosed herein, or in the alternative the anolyte 112 can include the inorganic boron cluster solid state electrolyte as disclosed herein in combination with other solid state electrolytes, that is not an inorganic boron cluster based electrolyte, such as sulfide solid state electrolytes, hydride solid state electrolytes, polymer solid state electrolytes, oxide solid state electrolytes, halide-type solid state electrolytes, plastic crystal solid state electrolytes, inorganic-organic plastic crystal solid state electrolytes, and combinations thereof.

The inorganic boron cluster solid state electrolyte in the electrochemical device 10 exhibits high compatibility with the anode 110, including metallic anodes such as Li, Na, Mg, Ca, Zn and Al, alloy anodes such as Si and Sn alloy anodes, conversion anodes, organic anodes and intercalation anodes such as graphite anodes. For example, the inorganic boron cluster solid state electrolyte supports a cycling coulombic efficiency (CE) greater than 90 % with the above noted anodes. The inorganic boron cluster solid state electrolyte also exhibits high compatibility with the cathodes noted above, e.g., a conversion cathode such as a sulfur cathode.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/- 10% of the measured value, while in other variations such known commercial and/or experimental measurement tolerances are +/- 5% of the measured value, while in still other variations such known commercial and/or experimental measurement tolerances are +/- 2.5% of the measured value. And in at least one variation, such known commercial and/or experimental measurement tolerances are +/- 1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. An electrolyte comprising:
a composite salt mixture comprising between 0.975 and 0.05 mole fraction of a first boron cluster salt, between 0.025 and 0.95 mole fraction of a second boron cluster salt, and between 0.025 and 0.90 mole fraction of a third boron cluster salt, the second boron cluster salt being different than the first boron cluster, the third boron cluster salt being different than the first and second boron cluster salts, and the sum of the mole fractions of the first, second, and third boron cluster salts equal to 1.000; and
an activation energy less than 0.65 eV at one or more temperatures above -30^{o}C.

2. The electrolyte according to claim 1, wherein the first boron cluster salt is a halogen-free boron cluster salt, the second boron cluster salt is a halogenated boron cluster salt, and the third boron cluster salt is a second halogenated boron cluster salt.

3. The electrolyte according to claim 2, wherein the second halogenated boron cluster salt has more bonded halogen atoms than the first halogenated boron cluster salt.

4. The electrolyte according to claim 2, wherein the second halogenated boron cluster salt has one or more different halogen atoms than the first halogenated boron cluster salt.

5. The electrolyte according to claim 1, wherein the first boron cluster salt is a first halogenated boron cluster salt, the second boron cluster salt is a second halogenated boron cluster salt, and the third boron cluster salt is a third halogenated boron cluster salt.

6. The electrolyte according to claim 5, wherein the third halogenated boron cluster salt has more bonded halogen atoms than the first halogenated boron cluster salt and the second halogenated boron cluster salt.

7. The electrolyte according to claim 6, wherein the third halogenated boron cluster salt has one or more different halogen atoms than the first halogenated boron cluster salt and the second halogenated boron cluster salt.

8. The electrolyte according to claim 1, wherein at least one of the first, second, and third boron cluster salts comprises:
a monovalent or multivalent halogenated boron cluster anion having the structure selected from the group consisting of:
[B_{y}H_{(y-z-i)}R_{z}Xᵢ]²⁻, [CB(_{y-1})H_{(y-z-i)}R_{z}Xᵢ]⁻ [C₂B_{(y-2)}H_{(y-t-j-1)}RₜXⱼ]⁻ [C₂B_{(y-3)}H_{(y-t-j)}RₜXⱼ]⁻ , and [C₂B_{(y-3)}H_{(y-t-j-1)}RₜXⱼ]²⁻, and wherein:
y is an integer within a range of 6 to 12;
(z+i) is an integer within a range of 0 to y;
(t+j) is an integer within a range of 0 to (y−1);
X is F, Cl, Br, I, halogenated alkyl group including CF_{3,} or a combination thereof; and
R is a linear, branched-chain, or cyclic C1-C18 alkyl or fluoroalkyl group.

9. The electrolyte according to claim 1 further comprising one or more cations selected from Li⁺,Na⁺,K⁺,Mg²⁺,Ca²⁺,Zn²⁺ and Al³⁺.

10. The electrolyte according to claim 1 further comprising at least one cation conductivity enhancing anion is selected from the group consisting of F⁻, Cl⁻, Br⁻,I⁻, RₓBF₄₋ₓ⁻, R_{y}PF_{6-y}⁻, SbF₆⁻, ClO₄⁻, SO₄²⁻, N(SO₂F)₂⁻, N(SO₂(CF₂)ₙCF₃)₂⁻, [NSO₂(CF₂)ₙ₊₁SO₂]⁻, CF₃(CF₂)ₙSO₃⁻, and combinations thereof, where: n is 0 to 5; x is 0 to 4; y is 0 to 6; and R is a linear, branched, or cyclic alkyl group that can be partially fluorinated, or fully fluorinated.

11. The electrolyte according to claim 1 further comprising a plastic crystal selected from the group consisting of an organic plastic crystal and an inorganic-organic plastic crystal, wherein the composite salt mixture is disposed in the plastic crystal.

12. The electrolyte according to claim 11, wherein the plastic crystal is the organic plastic crystal and the organic plastic crystal comprises a succinonitrile-glutaronitrile mixture.

13. The electrolyte according to claim 12, wherein a content of the organic plastic crystal in the electrolyte is between 0.01 and 50 molar percent.

14. The electrolyte according to claim 1 further comprising an ionic liquid additive and wherein the composite salt mixture is disposed in the ionic liquid additive.

15. The electrolyte according to claim 14, wherein a content of the ionic liquid additive in the electrolyte is between 0.01 and 50 molar percent.

16. An electrochemical cell comprising an anode, a cathode, and the electrolyte according to claim 1.

17. An electrochemical cell comprising:
an anode, a cathode, and a solid state electrolyte comprising:
a composite salt mixture comprising between 0.975 and 0.05 mole fraction of a first boron cluster salt, between 0.025 and 0,95 mole fraction of a second boron cluster salt that is different than the first boron cluster salt, and between 0.025 and 0.90 mole fraction of a third boron cluster salt that is different than the first boron cluster salt and the second boron cluster salt, and at least two of the first, second, and third boron cluster salts being halogenated boron cluster salts; and
an activation energy less than 0.65 eV at one or more temperatures above -30^{o}C.

18. The electrochemical cell according to claim 17, wherein the first boron cluster salt, the second boron cluster salt, and the third boron cluster salt are selected from the group consisting of a halogen-free boron cluster salt, a first halogenated boron cluster salt, and a second halogenated boron cluster salt, respectively, and a first halogenate boron cluster salt, a second halogenated boron cluster salt, and a third halogenated boron cluster salt, respectively.

19. A method comprising:
mechanochemically mixing two or more boron cluster salts and forming an inorganic boron cluster solid state electrolyte, the two or more boron cluster salts comprising between 0.975 and 0.05 mole fraction of a halogen-free boron cluster salt and between 0.025 and 0.95 mole fraction of a halogenated boron cluster salt, wherein the inorganic boron cluster solid state electrolyte, when heated to a temperature at or below 200 ^{o}C and cooled, has an activation energy that is less than an activation energy of the solid state electrolyte before being heated.

20. The method according to claim 19, wherein the two or more boron cluster salts are selected from the group consisting of:
a halogen-free boron cluster salt and a halogenated boron cluster salt;
a halogen-free boron cluster salt, a first halogenated boron cluster salt, and a second halogenated boron cluster salt; and
a first halogenated boron cluster salt, a second halogenated boron cluster salt, and a third halogenated boron cluster salt.
